(19) United States
(12) Patent Application Publication
(10) Pub. No.: US 2025/0356627 A1
(43) Pub. Date: Nov. 20, 2025

(54) METHOD AND DEVICE FOR MONITORING AND EVALUATING AN IMAGE CLASSIFICATION MODEL

(71) Applicant: Robert Bosch GmbH, Stuttgart (DE)

(72) Inventors: David Schoenleber, Karlsruhe (DE); Joseph Trotta, Adelfia (Bari) (IT)

(21) Appl. No.: 19/202,218

(22) Filed: May 8, 2025

(30) Foreign Application Priority Data
May 17, 2024 (DE) 10 2024 204 616.7

(51) Int. Cl. G06V 10/764; G06V 10/778

(52) U.S. Cl. CPC G06V 10/764; G06V 10/778

(57) ABSTRACT

A method and device for monitoring and evaluating a calibrated image classification model, in particular for use in automatic optical inspection including in the field of manufacturing components for identifying defects.

### FIELD

The present invention relates to a computer-implemented method and device for monitoring and evaluating an image classification model. Further embodiments of the present invention relate to an application of the method and to a manufacturing plant comprising such a device.

### BACKGROUND INFORMATION

In the field of automatic optical inspection (AOI), for example in the field of manufacturing, it is desirable to monitor the proper operation of the image classification models used and to evaluate the performance of the models. A class-labeled data set is typically required for monitoring and evaluating performance. However, at the point in time the image classification model is deployed, labeled data are usually not available. Monitoring therefore presents a challenge.

It is problematic, for example, if the model is deployed to classify images that differ from, or have little or no resemblance to, the images on which the model was trained. The classification of images that differ from those on which a model was trained is referred to as out-of-distribution detection (OOD). Conventional methods for recognizing OOD images require access to intermediate layers of the model and are therefore complex to implement and cannot be used intuitively in the evaluation.

### SUMMARY

In order to solve the problem, the present invention provides a computer-implemented method and a device.

One example embodiment of the present invention relates to a computer-implemented method for monitoring and evaluating a calibrated image classification model, wherein the method comprises:
classifying images by means of the calibrated image classification model, comprising predicting a softmax distribution;
and determining, for each image classified by means of the calibrated image classification model, a minimum class-dependent matching score based on a softmax distribution predicted for the particular image and on a characteristic softmax distribution of the classes of the calibrated image classification model;
and generating a visual output on a human-machine interface, which makes it possible for a user to analyze the performance of the calibrated image classification model, wherein the visual output comprises a class-specific representation for each class of the calibrated image classification model, and wherein, in a particular class-specific representation, each image classified into the particular class by means of the calibrated image classification model is displayed as a data point, wherein each data point is plotted as a softmax value of the image of the particular class against the associated class-dependent matching score, and wherein each data point is displayed in color, wherein a color is selected based on the class of the minimum class-dependent matching score of the particular image.

According to an example embodiment of the method of the present invention, monitoring and evaluation are carried out on the predicted softmax distribution, i.e., on the softmax output, i.e., the class probabilities predicted by a classifier of the calibrated image classification model.

For each image, a minimum class-dependent matching score is determined based on the predicted softmax distribution and the characteristic softmax distribution of the classes of the calibrated image classification model. This minimum class-dependent matching score indicates the class for which, according to the predicted softmax distribution, there is the smallest deviation from the characteristic softmax distribution of the classes of the calibrated image classification model.

Moreover, a visual output is generated on a human-machine interface, which makes it possible for a user to analyze the performance of the calibrated image classification model. For this purpose, the visual output comprises a class-specific representation for each class of the calibrated image classification model. In a particular class-specific representation, each image classified into the particular class by means of the calibrated image classification model is displayed as a data point so that each class-specific representation comprises a plurality of data points, namely as many as the number of images that are classified into the particular class by means of the calibrated image classification model. The classification into the particular class k is carried out using the predicted softmax values p with k=argmaxₖ p(y=k|x′). In the class-specific representation of the visual output, each data point is displayed as a data point in a diagram, wherein each data point is plotted as the softmax value of the image of the particular class against the associated class-dependent matching score. Thus, the diagram shows a data point as the softmax value of the image of the particular class underlying the data point against the associated class-dependent matching score. A class-specific representation means that a separate diagram is generated and displayed for each class of the calibrated image classification model. In the diagram, each data point is displayed in color. The color of the colored representation is based on the class for which the image underlying the data point has the minimum class-dependent matching score.

For example, in the class-specific representation of a first class, the images that are classified into the first class by means of the calibrated image classification model using the predicted softmax distribution are displayed as data points. That is to say, the first class in each case has the highest softmax value in the predicted softmax distribution of the images. Each data point is then plotted in the diagram as the softmax value of the first class against the associated class-dependent matching score, namely the matching score for the first class.

According to an example embodiment of the present invention, in the class-specific representation of each class, the visual output provides information on how highly the associated class-dependent matching score is for the particular softmax value of the image underlying the particular data point. The smaller the class-dependent matching score, the more reliably the classification of the particular displayed class works.

Each data point is displayed in color. If the image underlying the data point has the minimum class-dependent matching score for the first class, the data point is displayed in a first color that indicates the first class. If the image underlying the data point has the minimum class-dependent matching score for a second class, the data point is displayed in a second color that indicates the second class. In this way, further classes and further colors are processed accordingly.

In the class-specific representation of each class, the visual output thus provides information about when the highest softmax score of the image underlying the data point corresponds to the class of the particular class-specific representation, but the softmax distribution is closer to another class, namely the class for which the image underlying the data point has the minimum class-dependent matching score. This information can indicate that the image underlying the particular data point can be classified by the model only with difficulty or ambiguously.

Furthermore, according to an example embodiment of the present invention, the representation in the visual output described above results in a plurality of data points, which are based on images that the model has difficulty distinguishing, being arranged in the diagram in a line-like manner with a kind of bend point, wherein a color change occurs at the bend point. This information can indicate that the model has difficulty distinguishing the images of the classes underlying the respective data points according to the color representation of the data points.

The representation of the data points in the class-specific representation of the visual output in a diagram, the resulting arrangement and the color representation make it possible for the user to directly obtain information about the internal state prevailing in a technical system, namely the function and performance of the calibrated image classification model, based on the information displayed. Based on the representation and the resulting information about the internal state, the user can undertake appropriate actions and/or interact with the calibrated image classification model in order, for example, to improve the function and performance of the model and to avoid malfunctions.

According to an example embodiment of the present invention, in the case of a large number of classes, it can be provided that, in particular in order to obtain a better overview, not every class is displayed in the class-specific representation in relation to the minimum class-dependent matching score. For example, a number of data points per minimum class-dependent matching score can be determined, and only the classes whose frequency exceeds a defined threshold value, for example 1% of the number of determined data points, are then displayed. Alternatively, a plurality of separate visualizations of class-specific representation can be created, in which a subset of the classes is displayed in relation to the minimum class-dependent matching score.

According to one example embodiment of the present invention, based on a selection of a data point in a particular class-specific representation of the visual output, the image underlying the data point is displayed in the visual output on the human-machine interface. Selecting the data point causes the image underlying the data point to be displayed. Selecting can be carried out, for example, by means of a corresponding user input or via a suitable input of the human-machine interface. A suitable input is, for example, an input device such as a computer mouse, a keyboard, a trackpad and/or a touchscreen. Selecting a data point can, for example, comprise moving or holding a mouse pointer or finger over the data point, in the sense of a mouseover effect. In this way, the images underlying the respective data points are made accessible to a user in an intuitive and rapid manner. A user can thus rapidly and efficiently gain insight into the specific image underlying a particular data point.

According to an example embodiment of the present invention, the representation of the data points in the class-specific representation of the visual output in a diagram, the resulting arrangement and color representation make an easy-to-understand and intuitive representation of the data points possible and allow a user to make an intuitive selection of which specific images they would like to display by selecting the corresponding data points. The arrangement and color representation of the data points resulting in the diagram is suitable for indicating which images cause or can cause difficulties in the model and should therefore be displayed in order to gain insight. The representation of the data points provides the user with information that makes it possible for them to efficiently perform an interactive search and selection of images.

According to an example embodiment of the present invention, a user can thus gain insight into the specific images for which the described classification difficulties arise. For example, by selecting the data points, the user can display the desired images one after the other and thus rapidly and easily discover similarities and/or differences between the displayed images. A user can thus examine the images that the model sees during deployment and gain a better understanding of difficulties and/or problems of the image classification model that were not foreseeable, in particular at the point in time of training.

According to one example embodiment of the present invention, based on the visual output, at least one evaluation of the calibrated image classification model is derived, wherein the evaluation comprises: identifying at least one class for which the calibrated image classification model provides a classification to be checked and/or identifying at least one data point, and in particular the image underlying the data point, for which the calibrated image classification model provides a classification to be checked. A classification to be checked is understood to mean, for example, an unsatisfactory classification or a questionable classification. An unsatisfactory or questionable classification is understood to mean, for example, that difficulties in classification arise in connection with this class. For example, two or more classes can also be identified that the model can distinguish only with difficulty or ambiguously during classification.

For example, a comparatively higher class-dependent matching score can indicate that classification difficulties arise in connection with this class. A comparatively low class-dependent matching score can indicate that no classification difficulties arise in connection with this class.

For example, bends with color changes in the diagram can indicate that the model can distinguish these classes only with difficulty or ambiguously according to the color change during classification. Bends with color changes result in the arrangement in the diagram of the class-specific representation for data points for which the highest softmax score of the image underlying the data point corresponds to the class of the particular class-specific representation, but the softmax distribution is closer to another class, namely the class for which the image underlying the data point has the minimum class-dependent matching score.

According to one example embodiment of the present invention, based on the evaluation of the calibrated image classification model, at least one of the following steps is carried out: a) training or retraining the calibrated image classification model on a modified training data set and/or b) modifying a class definition, at least of the class for which the calibrated image classification model provides a classification to be checked. A modified training data set can be improved compared to a previously used training data set, for example by adding or omitting images. In particular, a modified training data set can comprise images, or more images, of the class with which the model has difficulty. Class definitions are defined by domain experts, for example in the field of AOI on the basis of defects to be identified in the images. Such class definitions can often be somewhat arbitrary. Changing the class definition can therefore lead to improved model performance.

According to one example embodiment of the present invention, determining the minimum class-dependent matching score of each image based on the Kullback-Leibler divergence is carried out by comparing the predicted softmax distribution of the particular image and the characteristic softmax distribution of the classes of the image classification model. Therefore, the use of the Kullback-Leibler divergence can be advantageous since only the model prediction is required for the determination, and no information from intermediate layers of the model is needed, which is information that is typically not available during model deployment. For example, in arXiv:1911.11132, the Kullback-Leibler divergence is described as the KL matching score and is used to identify images whose softmax distribution differs from the softmax distribution of the images typically seen during training. In this connection, the KL matching score is used for determining the OOD property of an image.

As an alternative to the described Kullback-Leibler divergence, another OOD value that is available at the image level can be used. For example, the minimum class-dependent matching score of each image can be determined based on the cosine similarity of class-specific mean feature values (arXiv:2306.14920) or based on a distance between activation histograms (arXiv:2309.04837).

According to one example embodiment of the present invention, the characteristic softmax distribution of the image classification model is the mean softmax distribution of classes of a validation data set and/or a training data set of the calibrated image classification model. In this case, it may prove advantageous if the method comprises a step of determining the characteristic softmax distribution, namely in the form of the mean softmax distribution of the classes of the validation data set of the calibrated image classification model.

According to a further example embodiment of the present invention, it can be provided that the characteristic softmax distribution of the calibrated image classification model is determined based on softmax distributions recorded during the development of the model. The image distribution at the time of development is therefore recorded. This can be advantageous, for example, if no validation set and/or training data set is available.

According to one example embodiment of the present invention, the method for monitoring and evaluating a calibrated image classification model is carried out in real time, during the time of deployment of the calibrated image classification model for classifying images.

Further embodiments of the present invention relate to a device for monitoring and evaluating a calibrated image classification model, wherein the device comprises a computing device, wherein the computing device is designed to execute machine-readable instructions, upon execution of which by the computing device the method according to the described embodiments can be executed, and wherein the device comprises a human-machine interface, wherein a visual output on the human-machine interface can be initiated by executing the method according to the described embodiments, wherein the visual output comprises a class-specific representation for each class of the calibrated image classification model, and wherein, in a particular class-specific representation, each image classified into the particular class by means of the calibrated image classification model can be displayed as a data point, wherein each data point can be plotted as the maximum softmax value of the image of the particular class against the associated class-dependent matching score, and wherein each data point can be displayed in color, wherein a color can be selected based on the class of the minimum class-dependent matching score of the particular image.

According to one example embodiment of the present invention, upon a selection of a data point in a particular class-specific representation of the visual output, the image underlying the data point can be displayed in the visual output on the human-machine interface.

Further embodiments of the present invention relate to applying the method for monitoring a calibrated image classification model for automatic optical inspection (AOI), for example a calibrated image classification model used in the manufacture of components for automatic optical inspection of the components, wherein the calibrated image classification model is a multi-class model, wherein the calibrated image classification model is trained to classify defects according to defect types, wherein a defect type is assigned to a particular class of the calibrated image classification model.

In the field of manufacturing, an optical inspection of the manufactured component may be performed in order to ensure the quality of manufacturing steps. For example, unwanted damage such as scratches, contamination, breakage, deformation, discoloration or the like can thus be recognized. Optical inspection can be performed automatically, i.e., automatic optical inspection (AOI), in particular to increase efficiency and reduce costs. For example, a calibrated image classification model is used that undertakes a classification of images into classes based on the defects that occur. In this case, the calibrated image classification model is a multi-class classification model for classifying defect types.

Using the classification, it can be concluded, for example, in which manufacturing steps and/or in which parts of a manufacturing plant the classified defect type occurs. So that the classification works reliably, it is necessary to ensure that the calibrated image classification model works accordingly. For example, if the calibrated image classification model mixes certain classes or is no longer able to distinguish or recognize certain classes, such conclusions may no longer be valid. Furthermore, if the calibrated image classification model is unable to reliably distinguish between classes, this could also indicate that the images the model sees during deployment no longer resemble the images on which the model was trained. In both cases, the functionality and performance of the model are called into question.

The application of the above-described method for monitoring a calibrated image classification model for automatic optical inspection (AOI) according to the present invention, for example a calibrated image classification model used in the manufacture of components for automatic optical inspection of the components, can eliminate the problems described above in the manufacture and inspection of components.

Further example embodiments of the present relate to a system, for example a manufacturing plant, comprising a computing device that is designed for automatic optical inspection (AOI) by means of a calibrated image classification model, for example a calibrated image classification model that is used in the manufacture of components for the automatic optical inspection of the components, wherein the calibrated image classification model is a multi-class model, wherein the calibrated image classification model is trained to classify defects according to defect types, wherein a defect type is assigned to a particular class of the calibrated image classification model, and wherein the system comprises a device according to the described embodiments.

Further advantages can be found in the description herein and the figures. Exemplary embodiments of the present invention are shown in the figures and explained in more detail in the following description. Here, the same reference signs in different figures in each case denote the same elements or at least elements that are comparable in terms of their function. In the description of individual figures, reference may also be made to elements from other figures.

### BRIEF DESCRIPTION OF THE DRAWINGS

FIG. 1 shows steps of a method for monitoring and evaluating an image classification model, according to an example embodiment of the present invention.

FIG. 2 is a schematic representation of a visual output of a human-machine interface of a device designed to carry out the method according to FIG. 1, according to an example embodiment of the present invention.

### DETAILED DESCRIPTION OF EXAMPLE EMBODIMENTS

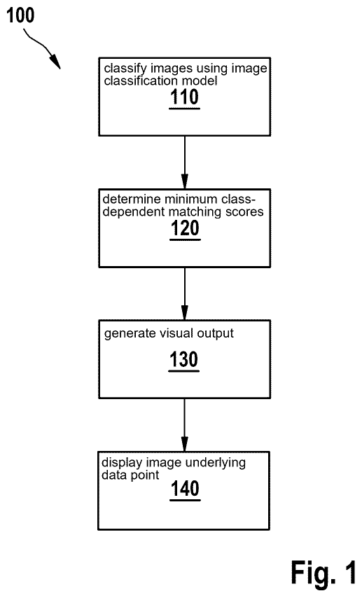

FIG. 1 shows steps of a method 100 for monitoring and evaluating a calibrated image classification model.

The calibrated image classification model is designed, for example trained on a suitable training data set, to classify images into corresponding classes k of the image classification model. For example, classification is carried out based on a predicted softmax distribution, wherein each image is classified into the class for which the softmax distribution has the largest softmax value.

The method 100 comprises the following steps:

A step 110 of classifying images by means of the image classification model comprising predicting a softmax distribution. The classification into the particular class k is carried out using the predicted softmax values p with k=argmaxₖ p(y=k|x′). An image is thus classified into class k, which comprises the highest softmax value in the predicted softmax distribution of the image.

The method 100 comprises a step 120 of determining, for each image classified by means of the calibrated image classification model, a minimum class-dependent matching score based on a softmax distribution predicted for the particular image and on a characteristic softmax distribution of the classes of the image classification model. This minimum class-dependent matching score indicates the class for which, according to the predicted softmax distribution, there is the smallest deviation from the characteristic softmax distribution of the classes of the image classification model.

The method 100 comprises a step 130 of generating a visual output on a human-machine interface, which makes it possible for a user to analyze the performance of the image classification model, wherein the visual output comprises a class-specific representation for each class of the image classification model. A class-specific representation means that a separate diagram is generated and displayed for each class of the image classification model.

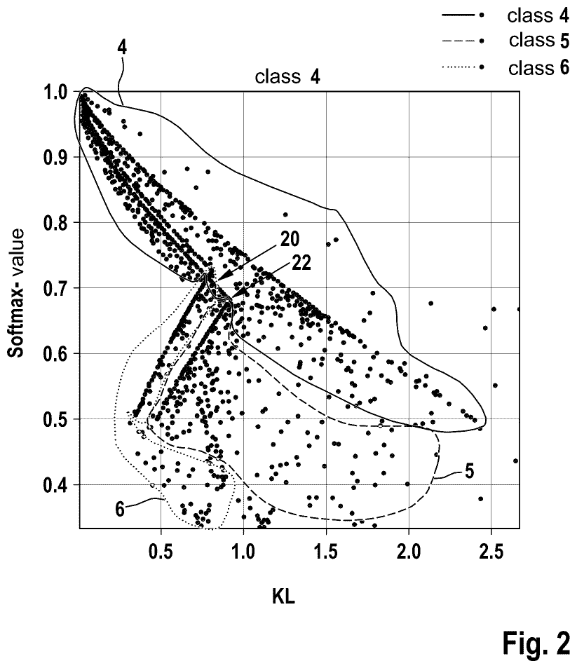

FIG. 2 shows an exemplary representation of a class-specific representation for a class of the image classification model. In the example, the class is referred to as “Class 4.”

In the class-specific representation of class 4, each image classified into class 4 by means of the image classification model is displayed as a data point, see the points shown in FIG. 2. The class-specific representation of class 4 comprises a plurality of data points, namely as many as the number of images that are classified into class 4 by means of the image classification model. Each data point is displayed in the class-specific representation of the visual output as a data point in a diagram, wherein each data point is plotted as the softmax value of the image of the particular class (of class 4 in the diagram shown in FIG. 2) against the associated class-dependent matching score KL. Thus, the diagram shows each data point as a softmax value of the image of the particular class underlying the data point against the associated class-dependent matching score.

In the class-specific representation of each class, the visual output provides information on how highly the associated class-dependent matching score is for the particular softmax value of the image underlying the particular data point. The smaller the class-dependent matching score, the more reliably the classification of the particular displayed class works for the image underlying the data point. For example, the classification works more reliably for the data points further to the left in the diagram in FIG. 2 than for the data points further to the right.

In the diagram, each data point is displayed in color. The color of the colored representation is based on the class for which the image underlying the data point has the minimum class-dependent matching score. An image does not necessarily have to have the minimum class-dependent matching score for the class classified by the highest softmax value. It should be noted that the said color representation in FIG. 2 is shown in a simplified manner due to the black and white illustration.

In the diagram in FIG. 2, the data points that have the minimum class-dependent matching score for class 4 are shown in a color that indicates class 4. The data points that have the minimum class-dependent matching score for class 5 are shown in a color that indicates class 5. The data points that have the minimum class-dependent matching score for class 6 are shown in a color that indicates class 6. For better understanding, the data points in FIG. 2 are shown according to their particular color and surrounded by lines with the reference signs 4, 5, 6, in order to indicate the color assignment in the present black/white representation. These lines are not provided in the visual output according to the present invention and are not required due to the color representation.

In the diagram according to FIG. 2, no data points in the example are displayed in a color that indicates one of the classes 1 to 3. This means that, in the present case, no image classified in class 4 has the minimum class-dependent matching score for any of the classes 1 to 3.

In the diagram according to FIG. 2, the arrangement results in two bend points. They are provided with the reference signs 20, 22. At each of these bend points, a color change in the color representation of the data points can be seen. Bends with color changes result in the arrangement in the diagram of the class-specific representation for data points for which the highest softmax score of the image underlying the data point corresponds to the class 4 of the particular class-specific representation, but the softmax distribution is closer to another class, namely the class for which the image underlying the data point has the minimum class-dependent matching score. At the bend point 20, a change between the color for class 4 and the color for class 6 can be seen. At the bend point 22, a change between the color for class 4 and the color for class 5 can be seen. For example, bends with color changes in the diagram can indicate that the model for some images can distinguish these classes only with difficulty or ambiguously according to the color change during classification.

According to the method, based on a selection of a data point in a particular class-specific representation of the visual output, the image underlying the data point is displayed in the visual output on the human-machine interface, step 140. Selecting the data point causes the image underlying the data point to be displayed. Selecting can be carried out, for example, by means of a corresponding user input or via a suitable input of the human-machine interface. A suitable input is, for example, an input device such as a computer mouse, a keyboard, a trackpad and/or a touchscreen. Selecting a data point can, for example, comprise moving or holding a mouse pointer or finger over the data point, in the sense of a mouseover effect. In this way, the images underlying the respective data points are made accessible to a user in an intuitive and rapid manner. A user can thus rapidly and efficiently gain insight into the specific image underlying a particular data point.

The representation of the data points in the class-specific representation of the visual output in a diagram, the resulting arrangement and color representation make an easy-to-understand and intuitive representation of the data points possible and allow a user to make an intuitive selection of which specific images they would like to display by selecting the corresponding data points. The arrangement and color representation of the data points resulting in the diagram is suitable for indicating which images cause or can cause difficulties in the model and should therefore be displayed in order to gain insight. The representation of the data points provides the user with information that makes it possible for them to efficiently perform an interactive search and selection of images.

A user can thus gain insight into the specific images for which the described classification difficulties arise. For example, by selecting the data points, the user can display the desired images one after the other and thus rapidly and easily discover similarities and/or differences between the displayed images. A user can thus examine the images that the model sees during deployment and gain a better understanding of difficulties and/or problems of the image classification model that were not foreseeable, in particular at the point in time of training.

According to one embodiment, determining the minimum class-dependent matching score of each image based on the Kullback-Leibler divergence, minₖKL[p(y|x)∥dk], is carried out by comparing the predicted softmax distribution of the particular image and the characteristic softmax distribution dₖ= [symbol] ₓ, ˜X[p(y|x′)] of the classes of the image classification model. Therefore, the use of the Kullback-Leibler divergence can be advantageous since only the model prediction is required for the determination, and no information from intermediate layers of the model is needed, which is information that is typically not available during model deployment. For example, in arXiv:1911.11132, the Kullback-Leibler divergence is described as the KL matching score and is used to identify images whose softmax distribution differs from the softmax distribution of the images typically seen during training. In this connection, the KL matching score is used for determining the OOD property of an image.

According to one embodiment, the characteristic softmax distribution of the image classification model is the mean softmax distribution of classes of a validation data set and/or a training data set of the image classification model. In this case, it may prove advantageous if the method comprises a step of determining the characteristic softmax distribution, namely in the form of the mean softmax distribution dₖ= [symbol] ₓ, ˜X [p(y|x′)] of the classes of the validation data set of the calibrated image classification model.

1. A computer-implemented method (100) for monitoring and evaluating a calibrated image classification model, wherein the method comprises:
classifying (110) images by means of the calibrated image classification model, comprising predicting a softmax distribution;
determining (120), for each image classified by means of the calibrated image classification model, a minimum class-dependent matching score based on a softmax distribution predicted for the particular image and on a characteristic softmax distribution of the classes of the calibrated image classification model, wherein determining the minimum class-dependent matching score of each image based on the Kullback-Leibler divergence is carried out by comparing the predicted softmax distribution of the particular image and the characteristic softmax distribution of the classes of the calibrated image classification model;
and generating (130) a visual output on a human-machine interface, which makes it possible for a user to analyze the performance of the calibrated image classification model, wherein the visual output comprises a class-specific representation for each class of the calibrated image classification model, and wherein, in a particular class-specific representation, each image classified into the particular class by means of the calibrated image classification model is displayed as a data point, wherein each data point is plotted as a softmax value of the image of the particular class against the associated class-dependent matching score, and wherein each data point is displayed in color, wherein a color is selected based on the class of the minimum class-dependent matching score of the particular image.

2. The method according to claim 1, wherein, based on a selection of a data point in a particular class-specific representation of the visual output, the image underlying the data point is displayed in the visual output on the human-machine interface (140).

3. The method according to one of claim 1 or 2, wherein, based on the visual output, at least one evaluation of the calibrated image classification model is derived, wherein the evaluation comprises: identifying at least one class for which the calibrated image classification model provides a classification to be checked and/or identifying at least one data point, and in particular the image underlying the data point, for which the calibrated image classification model provides a classification to be checked.

4. The method according to claim 3, wherein, based on the evaluation of the calibrated image classification model, at least one of the following steps is carried out: a) training the calibrated image classification model on a new training data set and/or b) revising a class definition of at least the class for which the calibrated image classification model provides a classification to be checked.

5. The method according to one of the preceding claims, wherein the characteristic softmax distribution of the calibrated image classification model is the mean softmax distribution of classes of a validation data set and/or a training data set of the calibrated image classification model.

6. The method according to claim 1, wherein the characteristic softmax distribution of the calibrated image classification model is determined based on softmax distributions recorded during the development of the model.

7. The method according to one of the preceding claims, wherein the method for monitoring and evaluating a calibrated image classification model is carried out in real time, during the time of deployment of the calibrated image classification model for classifying images.

8. A device for monitoring and evaluating a calibrated image classification model, wherein the device comprises a computing device, wherein the computing device is designed to execute machine-readable instructions, upon execution of which by the computing device the method according to one of claims 1 to 7 can be executed, and wherein the device comprises a human-machine interface, wherein a visual output on the human-machine interface can be initiated by executing the method according to one of claims 1 to 7, wherein the visual output comprises a class-specific representation for each class of the calibrated image classification model, and wherein, in a particular class-specific representation, each image classified into the particular class by means of the calibrated image classification model can be displayed as a data point, wherein each data point can be plotted as the maximum softmax value of the image of the particular class against the associated class-dependent matching score, and wherein each data point can be displayed in color, wherein a color can be selected based on the class of the minimum class-dependent matching score of the particular image.

9. The device according to claim 8, based on a selection of a data point in a particular class-specific representation of the visual output, the image underlying the data point can be displayed in the visual output on the human-machine interface.

10. An application of the method for monitoring a calibrated image classification model for automatic optical inspection (AOI), for example a calibrated image classification model used in the manufacture of components for automatic optical inspection of the components, wherein the calibrated image classification model is a multi-class model, wherein the calibrated image classification model is trained to classify defects according to defect types, wherein a defect type is assigned to a particular class of the calibrated image classification model.

11. A system, for example a manufacturing plant, comprising a computing device that is designed for automatic optical inspection (AOI) by means of a calibrated image classification model, for example a calibrated image classification model that is used in the manufacture of components for the automatic optical inspection of the components, wherein the calibrated image classification model is a multi-class model, wherein the calibrated image classification model is trained to classify defects according to defect types, wherein a defect type is assigned to a particular class of the calibrated image classification model, and wherein the system comprises a device according to one of claim 8 or 9.
